(19) United States
(12) Patent Application Publication
(10) Pub. No.: US 2003/0116945 A1
(43) Pub. Date: Jun. 26, 2003

(54) Passenger protecting device

(75) Inventor: Kazuhiro Abe, Echi-gun (JP)

Correspondence Address: KANESAKA AND TAKEUCHI, 1423 Powhatan Street, Alexandria, VA, 22314, US

(73) Assignee: TAKATA CORPORATION

(21) Appl. No.: 10/307,327

(22) Filed: Dec. 2, 2002

(30) Foreign Application Priority Data
Dec. 25, 2001 (JP) 2001-392078

(51) Int. Cl. B60R 21/24

(52) U.S. Cl. 280/729

(57) ABSTRACT

A passenger protecting device for protecting a person in a vehicle includes an arm-protecting airbag to be inflated in front of an arm of the passenger, and a gas generator connected to the arm-protecting airbag for inflating the same. The arm-protecting airbag may be formed with a knee bag, a driver airbag or passenger airbag.

### BACKGROUND OF THE INVENTION AND RELATED ART STATEMENT

The present invention relates to a passenger protecting device for protecting arms of a passenger in a vehicle in case of vehicle collision, and more specifically, relates to a passenger protecting device including an airbag.

It has been known that there are protective devices, such as an airbag device provided in a steering wheel for protecting a driver, an airbag device provided in an instrument panel in front of the front passenger seat for protecting an front passenger, and a knee-bag device to be expanded in front of legs of the passenger in case of vehicle collision.

It is an object of the present invention to provide a protecting device for protecting a passenger by receiving arms of the passenger by an airbag in case of vehicle collision.

### SUMMARY OF THE INVENTION

A passenger protecting device of the present invention includes an arm-protecting airbag to be inflated in front of arms of a vehicle passenger, and a gas generator for inflating the airbag.

In such a passenger protecting device, the airbag is inflated in front of the arms of the passenger to receive and protect the same in case of emergency such as a collision or the like.

In the present invention, the gas generator may be shared with a knee-bag device for protecting legs of the passenger, an airbag device for a driver seat, or an airbag device for a front passenger seat. In this arrangement, the number of gas generators to be installed may be minimized.

In this case, the arm-protecting airbag may be communicated with the airbag in the knee-bag device, the airbag in the airbag device for a driver seat, or the airbag in the airbag device for a front passenger seat. In this case, gas from a gas generator is introduced into the arm-protecting airbag through the knee-bag, the airbag for a driver seat, or the airbag for a front passenger seat. In this passenger protecting device, the arm-protecting airbag may be folded and stored integrally with the knee-bag, the airbag for the driver seat, or the airbag for the front passenger seat.

### BRIEF DESCRIPTION OF THE DRAWINGS

FIG. 1 is a perspective view showing an operation of a passenger protecting device according to the first embodiment of the present invention.

FIG. 2(a) is a side view of the passenger protecting device shown in FIG. 1 in the operating state, and FIG. 2(b) is a cross sectional view taken along line 2(b)-2(b) in FIG. 2(a).

FIG. 3 is a perspective view showing an operation of a passenger protecting device according to the second embodiment of the present invention.

FIG. 4 is a perspective view showing an operation of a passenger protecting device according to the third embodiment of the present invention.

FIG. 5 is a perspective view showing an operation of a passenger protecting device according to the fourth embodiment of the present invention.

FIG. 6 is a perspective view showing an operation of a passenger protecting device according to the fifth embodiment of the present invention.

FIG. 7 is a drawing viewed from below and showing the operation of the passenger protecting device according to the fifth embodiment of the present invention.

FIG. 8 is a drawing viewed from below and showing an operation of a passenger protecting device according to the sixth embodiment of the present invention.

FIG. 9 is a perspective view showing an operation of a passenger protection device according to the seventh embodiment of the present invention.

FIG. 10 is a side view of the device shown in FIG. 9 in operation.

### DETAILED DESCRIPTION OF PREFERRED EMBODIMENTS

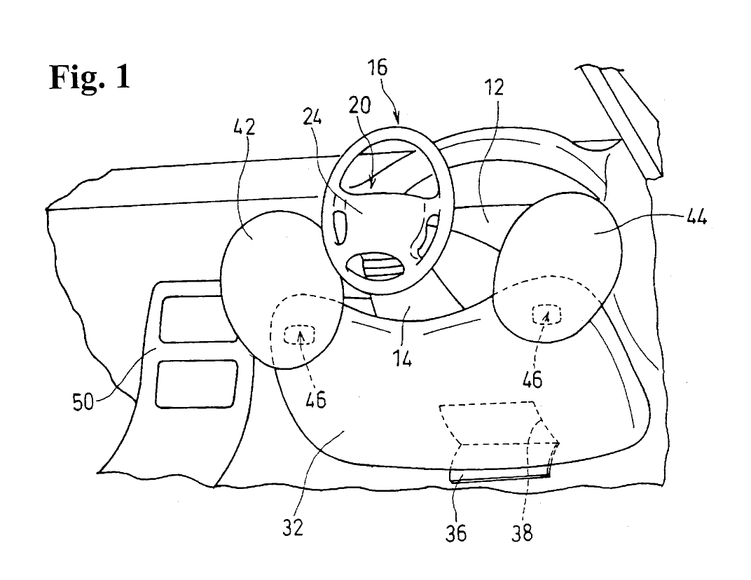

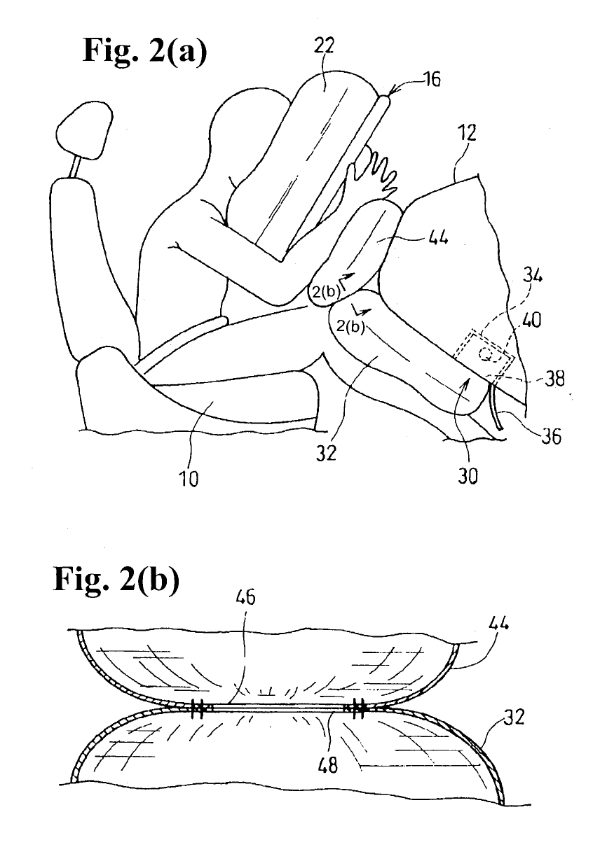

Hereunder, embodiments of the present invention will be described with reference to the accompanied drawings. FIG. 1 is a perspective view showing an inflated state of a knee-bag and an arm-protecting airbag of a passenger protection device according to the first embodiment of the present invention. FIG. 2(a) is a side view showing a state in which the airbag for a driver seat is also inflated, and FIG. 2(b) is a cross sectional view taken along line 2(b)-2(b) in FIG. 2(a). In the description below, the lateral direction represents the left-and-right direction of a vehicle, and the front-and-rear direction represents the front-and-rear direction of the vehicle.

A steering column (not shown) is projected from an instrument panel 12 located in front of a driver seat 10. A steering column cover 14 covers the steering column. A distal end of the steering shaft projected from the steering column is attached with a steering wheel 16. The steering wheel 16 is provided with an airbag device for the driver seat 20 therein. The airbag device for the driver seat 20 includes a retainer, an airbag 22 stored in the retainer, an inflator for inflating the airbag 22, and a module cover 24 for covering the folded airbag 22. According to the airbag device for the driver seat 20, as is well known, when the inflator is actuated, the airbag 22 is inflated, the module cover 24 is broken, and the airbag 22 is inflated so as to cover the steering wheel 16.

A knee-bag device 30 is installed in the instrument panel 12 under the steering column cover 14. An airbag (hereinafter referred to as a knee-bag) 32 of the knee-bag device 30 is stored in a container-shaped retainer (knee-bag retaining member) 34 provided in the instrument panel 12 in a folded state. A lid 36 is mounted on the retainer 34 so as to cover the folded knee-bag 32. The lid 36 closes an opening 38 for the knee-bag formed on the instrument panel 12. A gas generator 40 for inflating the knee-bag 32 is installed in the retainer 34. When the gas generator 40 is actuated, gas from the gas generator 40 is introduced into the knee-bag 32, and the knee-bag 32 is popped out through the opening 38 and is inflated in the interior of the vehicle while pushing the lid 36 to open.

As shown in FIG. 2(a), when the knee-bag 32 is popped out and inflated through the opening 38, it is deployed upwardly along a front surface of the instrument panel 12, and covers the lower half of the instrument panel 12 facing the leg portions of the passenger sitting on the driver seat. An upper portion of the knee-bag 32 is designed to reach an area near a lower portion of the steering column cover 14 in a completely inflated state.

A pair of arm-protecting airbags (hereinafter referred to as arm-bag) 42, 44 is connected to left and right sides of the upper portion of the knee-bag 32. In this embodiment, openings 46 for introducing the gas into the respective arm-bags 42, 44 are formed at lower portions of the respective arm-bags 42, 44. The knee-bag 32 is provided with openings 48 corresponding to the openings 46 for introducing the gas from the gas generator 40 on the left and right sides of the upper portion thereof. The respective arm-bags 42, 44 and the knee-bag 32 are connected by joining peripheral edges of these openings 46, 48 with each other by stitching or the like. The openings 46, 48 are formed on a surface of the knee-bag 32 facing the passenger. However, it may be formed on a surface facing the instrument panel 12.

As shown in FIG. 1, the arm-bag 42 connected on the left side of the knee-bag 32 is inflated so as to cover the left side area of the steering column cover 14 and the upper portion of a center console panel 50. The arm-bag 44 connected to the right side of the upper portion of the knee-bag 32 is inflated so as to cover the right side area of the steering column cover 14.

In the passenger protecting device of the present embodiment thus constructed, the respective arm-bags 42, 44 are folded and stored in the retainer 34 integrally with the knee-bag 32.

In case of emergency such as a vehicle collision, the gas generator 40 of the knee-bag device and the gas generator (not shown) of the airbag device for the driver seat are actuated, and thus the knee-bag 32 and the airbag 22 are inflated by the gases from the gas generators. The knee-bag 32 pushes and opens the lid 36 and starts to inflate in the interior of the vehicle, and is inflated in front of the leg potions of the passenger sitting on the driver seat as described above. The airbag 22 pushes and opens the module cover 24 and is deployed so as to cover the steering wheel 16, and inflated at a position in front of a face and an upper half body of the passenger.

In this embodiment, the gas introduced from the gas generator 40 to the knee-bag 32 flows through the knee-bag 32 to the respective arm-bags 42, 44, so that the arm-bags 42, 44 are inflated and deployed in spaces on the left and right between the instrument panel 12 and the backside of the steering wheel 16 to receive the left and right arms of the passenger.

This prevents the legs, the face, and the upper half body of the passenger from directly striking the vehicle body, and in addition, reliably prevents the left and right arms of the passenger from directly striking the vehicle body.

In the passenger protection device according to the present embodiment, since the arm-bags 42, 44 are connected to the knee-bag 32 respectively, in a normal use, the respective arm-bags 42, 44 may be folded and stored in the knee-bag device retainer 34 integrally with the knee-bag 32. The respective arm-bags 42, 44 may be inflated integrally with the knee-bag 32 by the gas generator 40 shared with the knee-bag 32. In this configuration, it is possible to eliminate a separate retainer or the like for storing the gas generator for inflating the respective arm-bags 42, 44 and the respective arm-bags 42, 44, and thus simplifies the structure, which is very economical.

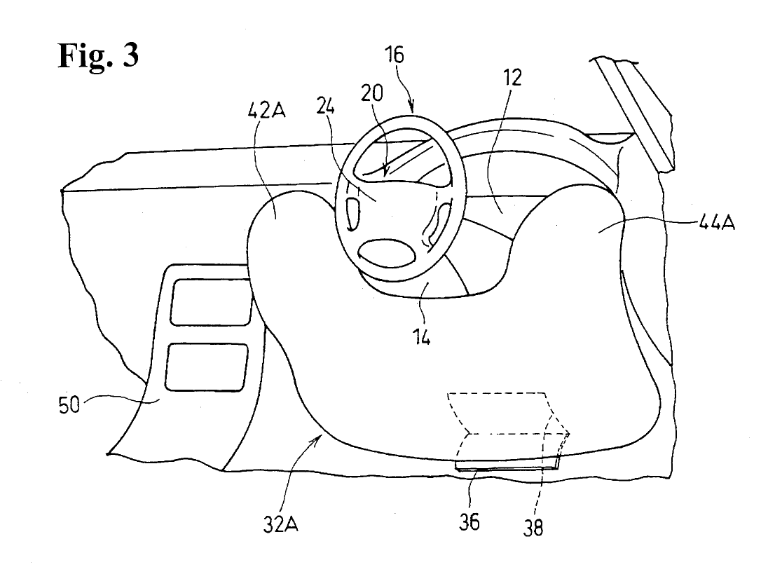

In this embodiment, the arm-bags 42, 44 and the knee-bag 32 are formed separately, and joined integrally with each other by stitching or the like. However, as in a passenger protecting device as shown in FIG. 3, the structure may be employed such that the arm-bag and the knee-bag are formed integrally of a continuous ground fabric (panel) in advance. FIG. 3 is a perspective view of the knee-bag in the passenger protecting device according to the second embodiment of the present invention in an inflated state.

The passenger protecting device shown in FIG. 3 is constructed such that arm-bags 42A, 44A overhanging from a knee-bag 32A so as to be inflated in front of the left and right arms of the passenger on the driver seat are provided on the left and right sides of the upper portion of the knee-bag 32A in the inflated state. In case of a vehicle collision, the respective arm bags 42A, 44A start to inflate integrally with the knee-bag 32A by gas from the gas generator 40. The arm-bag 42A is inflated so as to cover the left side area of the steering column cover 14 and the upper portion of the center console panel 50 along the front surface of the upper portion of the instrument panel 12, so that the left arm is received and protected. The arm-bag 44A is inflated so as to cover the right side area of the steering column cover 14 along the front surface of the upper portion of the instrument panel 12, so that the right arm is received and protected.

In this passenger protecting device for the driver seat shown in FIG. 3, since the knee-bag 32A and the arm-bags 42A, 44A overhanging from the knee-bag 32A are formed integrally in advance, it is not necessary to have a step of joining the arm-bags to the knee-bag by stitching or the like when manufacturing, thereby significantly simplifying the manufacturing process.

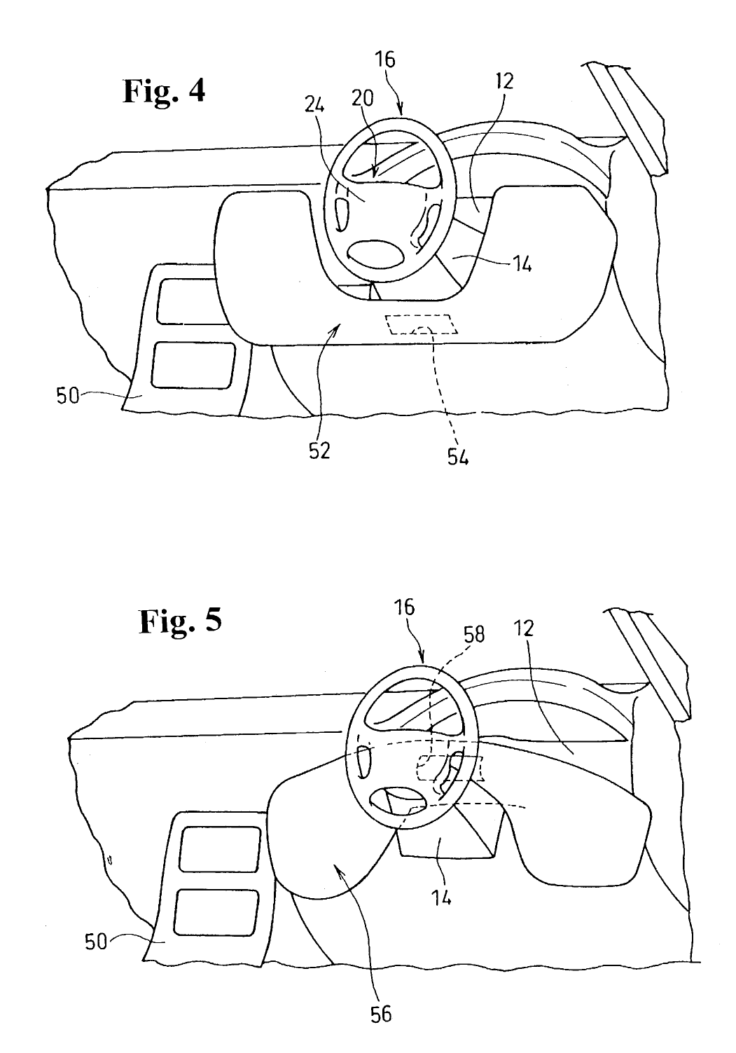

In the present embodiment, the respective arm-bags 42A, 44A are adapted to be inflated by the gas generator 40 for the knee-bag device. However, the arm-bag device with a gas generator for inflating the arm-bag may be provided separately from the knee-bag device or the airbag device as passenger protecting devices shown in the following FIG. 4 or FIG. 5. FIG. 4 and FIG. 5 are perspective views of the passenger protecting devices according to the third and fourth embodiments of the present invention in a state in which the arm-bags are inflated.

In the passenger protection device in FIG. 4, an arm-bag device includes an arm-bag 52 formed independently of the knee-bag or airbag, and a gas generator (not shown) for inflating the arm-bag 52, and is disposed in the instrument panel 12 located under the steering column cover 14. A reference numeral 54 indicates an opening for the arm-bag to expand. The opening 54 is normally closed by a lid.

In this passenger protection device, in case of a vehicle collision, the arm-bag 52 is inflated through the opening 54 into the interior of the vehicle by the gas from the gas generator and is spread substantially in a shape of the letter U, extending upward on the left and right sides, along the front surface of the instrument panel 12. The left half thereof is inflated so as to cover the left side area of the steering column cover 14 and the upper portion of the center console panel 50 so that the left arm of the passenger is received and protected. The right half thereof is inflated so as to cover the right side area of the steering column cover 14 so that the right arm of the passenger is received and protected.

In the passenger protecting device in FIG. 5, as in the case of the protecting device in FIG. 4, an arm-bag device including an arm-bag 56 provided independently from the knee-bag and the airbag. A gas generator (not shown) for inflating the arm-bag 56 is provided in the instrument panel 12 above the steering column cover 14. A reference numeral 58 indicates an opening for the arm-bag to inflate. The opening 58 is normally closed by a lid. The arm-bag device may be provided inside the steering column cover 14.

In this passenger protecting device, in case of a vehicle collision, the arm-bag 56 is inflated through the opening 58 into the interior of the vehicle by the gas from the gas generator and is spread substantially in an inverted shape of the letter U, extending upward on the left and right sides along the front surface of the upper portion of the instrument panel 12. The left half thereof is inflated so as to cover the left side area of the steering column cover 14 and the upper portion of the center console panel 50 so that the left arm of the passenger is received and protected. The right half thereof is inflated so as to cover the right side area of the steering column cover 14 so that the right arm of the passenger is received and protected.

In the passenger protecting devices shown in FIG. 4 and FIG. 5, the left halves of the arm-bags 54, 56 to be inflated in front of the left arm of the passenger on the driver seat and the right halves to be inflated in front of the right arm of the passenger on the driver seat are formed integrally. However, it is also possible to form openings for popping out the arm-bags respectively on the left and right sides of the steering column cover 14, and to provide separate arm-bag devices having arm-bags that inflate in front of the left arm and the right arm of the passenger on the driver seat respectively so as to face the respective openings.

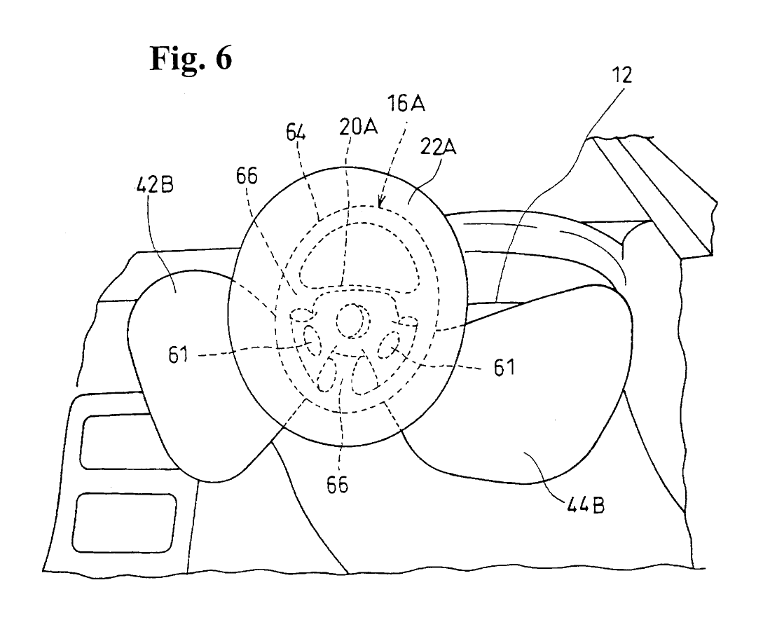

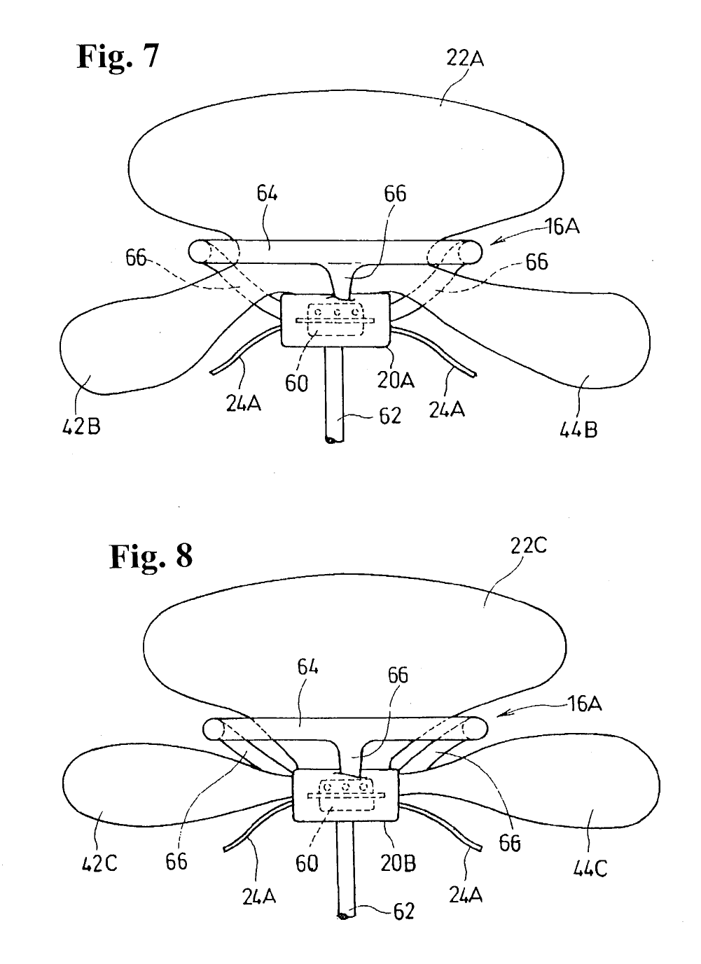

FIG. 6 is a perspective view of an airbag and an arm-bag in the passenger protecting device in an inflated state, and FIG. 7 is a drawing of a steering wheel viewed from below according to the fifth embodiment of the present invention, respectively.

In the passenger protecting device shown in FIGS. 6 and 7, a pair of arm-bags 42B, 44B to be inflated in front of the left and right arms of the passenger on the driver seat is respectively connected to both left and right sides of a rear surface (the surface opposite from the passenger) of an airbag 22A in an inflated state. The arm-bags 42B, 44B are communicated with the airbag 22A through communication ports 61, respectively. The airbag 22A is folded integrally with the arm-bags 42B, 44B and covered by a module cover 24A (FIG. 7) of the airbag device 20A.

In this passenger protecting device, in case of emergency such as a vehicle collision and the like, the airbag 22A is inflated by the gas from the gas generator 60 of the airbag device 20A, pushes and opens the module cover 24A, and is spread so as to cover the front surface of the steering wheel 16A.

At this moment, the gas introduced from the gas generator 60 into the airbag 22A flows also into the respective arm-bags 42B, 44B via the communication ports 61, thereby inflating the arm-bags 42B, 44B in front of the left and right arms of the passenger on the driver seat, respectively. As shown in FIGS. 6 and 7, in this embodiment, a steering wheel 16A includes three spoke members 66 extending from a wheel member 64 toward the center thereof. When the arm-bags 42B, 44B start to inflate, the arm-bags 42B, 44B start to inflate to the left and right sides passing through the spoke members.

The airbag 22A and the respective arm-bags 42B, 44B are adapted to be inflated integrally by a single gas generator 60 by connecting the arm-bags 42B, 44B to the airbag 22A, and bringing them into communication with each other via the communication ports 61 in the passenger protecting device in FIGS. 6 and 7. It is also possible to provide an airbag 22C and arm-bags 42C, 44C separately and connect them respectively to the gas generator 60 of an airbag device 20B so as to be capable of introducing the gas therefrom as in the passenger protecting device shown in FIG. 8.

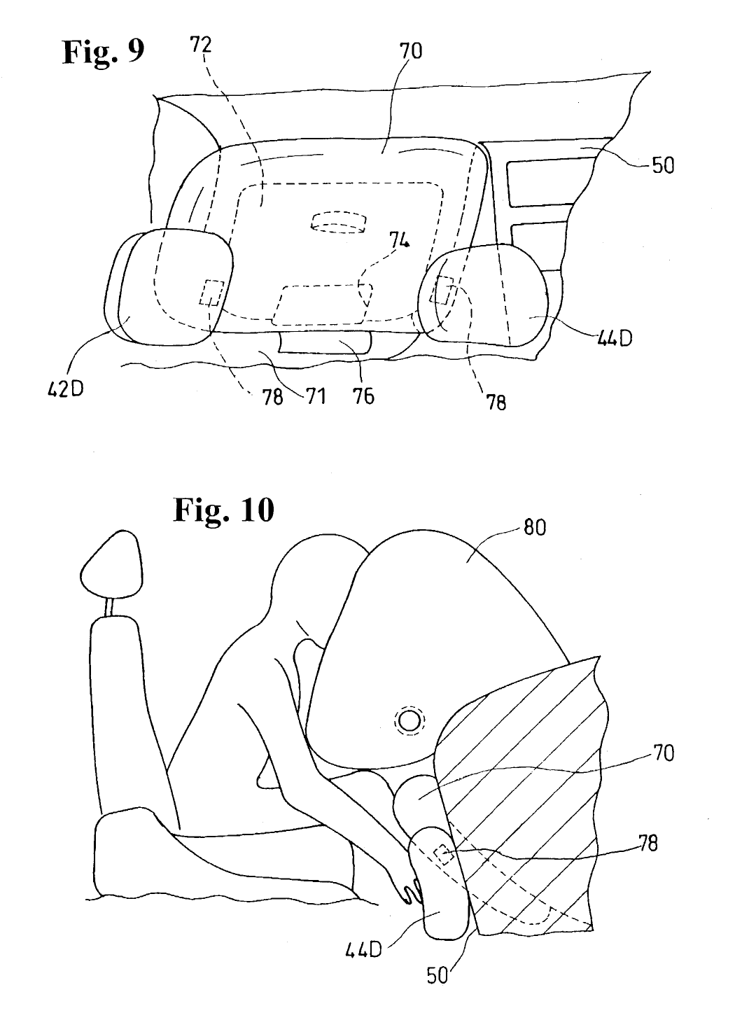

The present invention is applicable to an arm-protection device for a passenger on the front passenger seat of the vehicle as shown in FIG. 9 and FIG. 10. FIG. 9 is a perspective view of a knee-bag and arm-bags according to the seventh embodiment of the present invention in an inflated state, and FIG. 10 is a side view of the same.

A dash panel 71 located in front of the front passenger seat is provided with a knee-bag device 74 under a globe box 72. The knee-bag device 74 includes a knee-bag 70, a gas generator (not shown) for inflating the knee-bag 70, a container (not shown) for storing the folded knee-bag 70, a lid 76 for covering the front surface of the container and so on.

A pair of arm-bags 42D, 44D to be inflated at positions in front of the left and right arms of the passenger on the front passenger seat is respectively connected to the left and right sides of the lower portion of the knee-bag 70 in an inflated state. The respective arm-bags 42D, 44D and the knee-bag 70 are communicated with each other via communication ports 78, and the arm-bags 42D, 44D and the knee-bag 70 are inflated integrally by the gas introduced from the gas generator into the knee-bag 70 and further flown into the respective arm-bags 42D, 44D via the communication ports 78.

The knee-bag 70 and the arm-bags 42D, 44D receive the legs and the left and right arms of the passenger and protect the same, respectively. An airbag device for a front passenger seat for receiving the upper half body of the passenger on the front passenger seat is provided above the knee-bag device 74. A reference numeral 80 designates an inflated airbag for the front passenger seat.

As described thus far in detail, according to the present invention, the passenger protecting device for protecting the passenger by receiving the passenger arms by the airbag in case of a collision is provided.

While the invention has been explained with reference to the specific embodiments of the invention, the explanation is illustrative and the invention is limited only by the appended claims.

What is claimed is:

1. A passenger protecting device for protecting a person in a vehicle, comprising:
an arm-protecting airbag to be inflated in front of an arm of the passenger, and
a gas generator connected to the arm-protecting airbag for inflating the same.

2. A passenger protecting device according to claim 1, further comprising at least one of a knee-bag device with an airbag and a gas generator, a driver-protecting airbag device with an airbag and a gas generator, and a passenger-protecting airbag device with an airbag and a gas generator, said arm-protecting airbag communicating with one of the gas generators of said knee-bag device, driver-protecting airbag device and passenger-protecting airbag device as the gas generator for the arm-protecting airbag.

3. A passenger protecting device according to claim 2, wherein said arm-protecting airbag is connected to the airbag of the knee-bag device, the airbag of the driver-protecting airbag device, or the airbag of the passenger-protecting airbag device.

4. A passenger protecting device according to claim 3, wherein said arm-protecting airbag includes two arm-bags connected to one of the airbags of the knee-bag device, driver-protecting airbag device and passenger-protecting airbag device, said arm-bags on the airbag being spaced apart from each other.

5. A passenger protecting device according to claim 4, wherein said two arm-bags are separately formed with one of the airbags to be connected, and fixed to the one of the airbags.

6. A passenger protecting device according to claim 4, wherein said two arm-bags are integrally formed with the one of the airbags as parts thereof to project outwardly therefrom.

7. A passenger protecting device according to claim 6, wherein said two arm-bags project downwardly from a rear side of the airbag of the driver-protecting airbag device.

8. A passenger protecting device according to claim 6, wherein said two arm-bags project upwardly from an upper side of the airbag of the knee-bag device.
